(19) United States
(12) Patent Application Publication
(10) Pub. No.: US 2026/0062342 A1
(43) Pub. Date: Mar. 5, 2026

(54) THERMOCHROMIC MATERIALS WITH NANOPARTICLES

(71) Applicants: Nederlandse Organisatie voor toegepastnatuurwetenschappelijk onderzoek TNO, 's-Gravenhage (NL); Chemelot Scientific Participations B.V., Geleen (NL)

(72) Inventors: Cindy Po Keh YEUNG, Maastricht (NL); Arnoldus Dominicus Maria Roberto HABETS, Epen (NL); Pascal Jozef Paul BUSKENS, Kerkrade (NL); Nanning Joerg ARFSTEN; Daniel Enrico MANN, Aachen (DE)

(73) Assignees: Nederlandse Organisatie voor toegepastnatuurwetenschappelijk onderzoek TNO, 's-Gravenhage (NL); Chemelot Scientific Participations B.V., Geleen (NL)

(21) Appl. No.: 19/105,886

(22) PCT Filed: Sep. 4, 2023
(86) PCT No.: PCT/NL2023/050455

§ 371 Date: Feb. 24, 2025

(30) Foreign Application Priority Data
Sep. 2, 2022 (EP) 22193758.4

(51) Int. Cl. C03C 17/00; C03C 17/25

(52) U.S. Cl. CPC C03C 17/007; C03C 17/25; C03C 2217/228; C03C 2217/70; C03C 2218/111

(57) ABSTRACT

The disclosure pertains to thermochromic materials, such thermochromic coatings, comprising non-thermochromic nanoparticles. In embodiments of a preparation method for such materials, the nanoparticles are included in the liquid coating composition.

### FIELD

The invention pertains to thermochromic materials, for instance thermochromic coating compositions, which can be used for instance for smart glass applications (e.g. smart windows).

### INTRODUCTION

Vanadium (IV) oxide (VO₂) is known as being able to undergo a fully reversible metal-to-semiconductor phase transition between a low temperature (LT) monoclinic phase, VO₂ (M) and a high temperature (HT) rutile phase, VO₂ (R). The rutile phase is a semi-metal, reflecting and/or absorbing a wide range of solar wavelengths in the infrared. The monoclinic phase is a semiconductor and reflects and/or absorbs considerably less solar infrared light. It has been suggested to use VO₂ in window coatings to obtain glass windows for buildings which block more (near) infrared from sunlight with increasing temperatures. This can advantageously be used to decrease the energy consumption of buildings with windows, in particular for decreasing the energy consumption used for cooling (air conditioning).

The thermochromic switching temperature of VO₂ (M) is 68° C. Doping with metal ions can be used to decrease the switching temperature e.g. to 10-30° C.

WO 2020/242314 and WO 2021/242109 describe thermochromic coatings comprising VO₂ and SiO₂. Yeung et. al, Solar Energy Materials and Solar Cells, 230 (2021), 111238 describe the preparation of single layer thermochromic coatings comprising VO₂ (M) and SiO₂.

There remains a desire for thermochromic coatings having improved optical properties in combination with both good mechanical properties, such as mechanical robustness, and good thermochromic switching properties. Desired optical properties include a low refractive index and low absorption in the low temperature state. An important desired thermochromic switching property is low transmission in IR in the high temperature state.

### SUMMARY

The invention provides, in certain non-limiting aspects, a liquid coating composition, a method of preparing a liquid coating composition, a method of preparing a coated article using a liquid coating composition, a thermochromic coating, a thermochromic material, a coated article, and a method of preparing a coated article which includes preparation of a liquid coating composition.

The invention provides in embodiments a thermochromic coating comprising a thermochromic component and at least one type of non-thermochromic nanoparticles, the coating having the optical characteristics Tᵥᵢₛ×ΔT_{760-1360 nm}>1500, preferably Tᵥᵢₛ×ΔT_{760-1360 nm}>2000; wherein Tvis is the % visible light transmission and ΔT_{760-1360 nm} is the % transmission modulation in the range 760-1360 nm.

The invention provides in embodiments a thermochromic material comprising a thermochromic component, preferably monoclinic VO₂, which is optionally doped with a dopant; a binder, and at least one type of non-thermochromic nanoparticles, optionally in the form of granular material or a coating.

The invention provides in embodiments a method for preparing a thermochromic material, the method comprising: A) providing, as separate components, a thermochromic precursor component, a binder component, and a component containing, or consisting of, nanoparticles; preferably non-thermochromic nanoparticles; B) combining at least said components into a liquid composition; C) optionally applying the liquid composition onto a substrate; and D) drying and curing and/or annealing the liquid composition, optionally on the substrate, to give a thermochromic material, optionally in the form of a coated article comprising a solid thermochromic coating.

The invention provides in embodiments a liquid coating composition comprising, in a single liquid phase, a thermochromic precursor component, a binder component, and nanoparticles; wherein preferably the thermochromic precursor component comprises a vanadium organometallic complex, the binder component preferably comprises an alkoxysilane or an oligomerized alkoxysilane, and the nanoparticles are preferably non-thermochromic nanoparticles, for example silica nanoparticles and preferably have an average particle size of at least 10 nm or least 15 nm.

### BRIEF DESCRIPTION OF THE DRAWINGS

FIG. 1 is a photograph of an inventive coating (VSN-1) and a reference coating (VS).

FIG. 2 is a graph illustrating thermochromic properties of a reference coating (black) and an inventive coating (grey).

FIG. 3 is a graph illustrating the thermochromic properties of inventive coatings.

FIG. 4 shows TEM-EDX images of an inventive coating.

Any embodiments illustrated in the figures are examples only and do not limit the invention.

### DETAILED DESCRIPTION

The invention is based, in certain aspects, on the surprising finding that the thermochromic and/or optical properties of a thermochromic coating can be improved by including nanoparticles in the coating which are non-thermochromic and preferably are transparent for visible light. Transparency for visible light indicates that the constituent material of the nanoparticles has in bulk a low absorption of visible light. Non-thermochromic indicates the absence of thermochromic properties in the temperature range of 0° C. to 100°.

The size of the nanoparticles is typically such that the nanoparticles do not scatter in the visible light, e.g. below 100 nm. The size of the nanoparticles is for instance above 5 nm or above 10 nm to advantageously provide inhomogeneous distribution of VO₂ in the coating or thermochromic material.

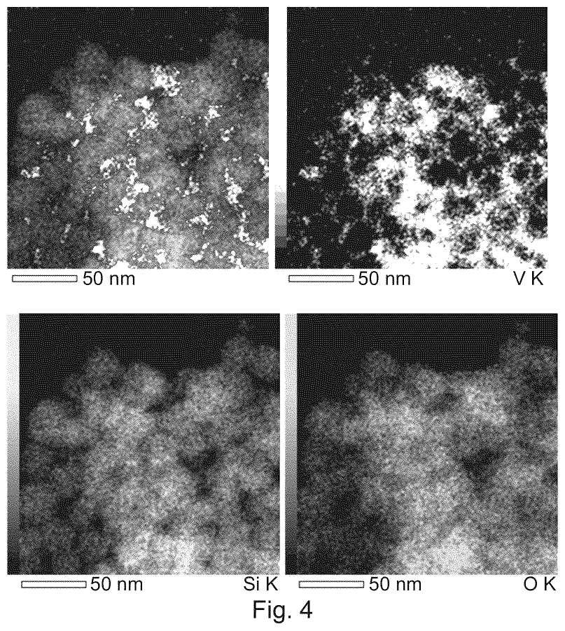

The thermochromic properties of the material are provided by crystalline nanodomains, or crystallites, of (doped) VO₂ that are monoclinic in the LT state. The nanoparticles in particular provide for zones of the thermochromic material that are free of VO₂ crystalline nanodomains. Accordingly, the VO₂ crystalline nanodomains exhibit an inhomogeneous distribution in the thermochromic material; illustrated in the example of FIG. 4. Comparison of FIG. 4 with FIG. 6 of Yeung et al 2021 shows the radical differences in spatial distribution of V atoms as determined with STEM-EDX and the unique ‘poor pockets’ in the V distribution in the example inventive thermochromic material that are not empty space but provided by the silica nanoparticles. The VO₂ crystallites are formed in interstices between the silica nanoparticles, as in the preferred preparation method the liquid coating composition contains the VO₂ precursor and the already formed nanoparticles, and the binder (e.g. silica binder) holds the material together in the solid thermochromic material. During the curing or annealing, the VO₂ precursor transforms to crystalline VO₂ but does not (significantly) invade the nanoparticles; the VO₂ crystallites are formed on and between the nanoparticles but not inside the silica nanoparticles. Without wishing to be bound by way of theory, the higher local concentration of dissolved and complexed V ions in the liquid between the (silica) nanoparticles, or the inhomogeneous distribution of V atoms in the liquid composition, relative to the total liquid coating composition including the non-thermochromic nanoparticles, may advantageously contribute to the formation of VO₂ crystallites with thermochromic properties between the non-thermochromic nanoparticles. The local concentration of V atoms in the liquid between the (silica) nanoparticles is e.g. higher than in a composition having the same amount of non-thermochromic material but entirely as a binder.

In an example embodiment, the thermochromic material hence comprises spherical pockets with diameter of at least 5 nm or at least 10 nm and generally below 100 nm that are poor in V, as determined with STEM-EDX wherein the pockets are substantially circular areas. Preferably, the pockets are rich in Si atoms as determined with STEM-EDX. Preferably, a field of 200×200 nm in an STEM-EDX image of the material contains at least 5 of such pockets.

The nanoparticles hence provide for optical dilution, without wishing to be bound by way of theory.

In the present disclosure, the term ‘cured coating’ is used to refer broadly to a solid coating that is obtained from a liquid coating composition, e.g. from the inventive liquid coating composition, typically using a preparation process comprises steps such as curing and/or annealing. Embodiments of the invention pertain in particular to a thermochromic cured coating.

The nanoparticles that are included in the liquid coating composition are incorporated into the thermochromic coating, i.e. in the cured coating. Suitably, the cured coating contains nanoparticles held together by a binder.

For the thermochromic material and coating, the binder is a solid material that holds the thermochromic particles, e.g. monoclinic VO₂ in place and binds all the components of the material together and, for the thermochromic coating, ensures proper adhesion of the coating to the substrate surface. The binder is a third component in addition to the nanoparticles and monoclinic VO₂.

Furthermore, advantageously the inventive coating can have a relatively large thickness, such as above 150 nm, or above 200 nm, or even above 500 nm while maintaining colour neutrality. Herein colour neutrality indicates the lack of visible colour of the coating. The larger coating thickness advantageously makes the visual appearance of the coating less susceptible to variations in the thickness of the coating, in particular by moving the thickness out of the quarter-wavelength range for visible light (visible light: 400-700 nm). The larger coating thickness may also advantageously improve processability of the coating. The binder may contribute to mechanical properties of the coating. The coating is preferably a single layer coating having a thickness of e.g. above 150 nm or even above 500 nm.

The present invention in an aspect provides a thermochromic coating comprising a thermochromic component and at least one type of non-thermochromic nanoparticles; and preferably a solid binder material holding together the thermochromic component, in particular monoclinic VO₂ crystallites, and the non-thermochromic nanoparticles. The coating is preferably obtainable by, or obtained, with, the inventive preparation methods.

The coating preferably has the optical characteristics Tᵥᵢₛ×ΔT_{760-1360 nm}>1500, more preferably above 2000.

Herein Tᵥᵢₛ is the % visible light transmission and ΔT_{760-1360 nm} is the % modulation of the solar transmission in the range 760-1360 nm. Tᵥᵢₛ is measured at a temperature lower than the thermochromic switching temperature. The value ΔT_{760-1360 nm} is e.g. calculated using following formula:

$$Δ {T}_{760 - 1360 nm} = {τ}_{e 760 - 1360 nm} ( cold ) - {τ}_{e 760 - 1360 nm} ( hot )$$

wherein τ_{e760-1360 nm} (cold) is the solar direct transmission of the material in the wavelength region between 760-1360 nm at a temperature lower than the thermochromic switching temperature and τₑ₇₆₀₋₁₃₆₀ nm (hot) is the solar direct transmission of the material in the wavelength region between 760-1360 nm at a temperature above the thermochromic switching temperature; see further formula A-2 hereinafter. For the solar direct transmission, see formula A-3 hereinafter.

Tᵥᵢₛ and/or T_{760-1360 nm} are for instance measured according to standard NEN-EN 410, in particular according to NEN-EN 410:2011. This European Standard specifies methods of determining the luminous and solar characteristics of glazing in buildings. Tᵥᵢₛ and/or T_{760-1360 nm} can also be measured using Method A as described hereinafter; in particular with optical measurement method A-1. Tᵥᵢₛ is e.g. as defined in formula A-1 specified hereinafter under Method A.

Tᵥᵢₛ×ΔT 760-1360 nm can be calculated by multiplication of the numeric percentage values of Tᵥᵢₛ and ΔT_{760-1360 nm}.

Accordingly, the invention provides the remarkable feature and insight that when non-thermochromic nanoparticles are added to the coating system, e.g. to a SiO₂/VO₂ two-component coating system with optional dopants, the solar modulation strongly increases in the 760-1360 nm range without a decrease in visible transmission. The range 760-1360 nm is of specific interest because of the high intensity of solar infrared light in this range, and because this range is complementary to the range of solar infrared light above 1360 nm that can be permanently blocked by a low-e coating.

The thermochromic coating is for example a cured coating.

In a further embodiment, the thermochromic material is introduced in the form of a thermochromic pigment into the coating.

Embodiments of the invention pertain to a solid thermochromic material comprising a thermochromic component, e.g. monoclinic VO₂, i.e. crystalline VO₂ that is monoclinic in the LT state, e.g. below 20° C., which material is optionally doped with a dopant; a binder, and at least one type of preferably non-thermochromic nanoparticles, wherein the material is optionally in the form of granular material or a coating. The binder is e.g. a dielectric binder and is preferably silica.

Preferably, the non-thermochromic nanoparticles are dielectric nanoparticles, e.g. metal oxide nanoparticles, more preferably silica nanoparticles. In a preferred embodiment, the nanoparticles, in particular the non-thermochromic nanoparticles, have an average particle size of at least 15 nm, and/or up to 200 nm or up to 100 nm; more preferably with said dielectric nanoparticles.

The invention also pertains to the thermochromic material as discussed in granular form, e.g. as a powder.

The thermochromic material in granular form is for instance a pigment composition, for example an IR pigment. The thermochromic material is for instance a powder. In an embodiment, the thermochromic material is in particulate form. In a further embodiment, the thermochromic material is introduced in the form of a thermochromic pigment into the coating.

The invention also pertains to an article comprising the thermochromic material in granular form, e.g. comprising particles of solid thermochromic material. The article is e.g. a foil or a film. The article comprises the particles of the thermochromic material and e.g. a matrix such as a polymer matrix. The film comprises e.g. a layer comprising particles of the thermochromic material and a matrix and optionally additional layers, these layers are e.g. laminated. The additional layers e.g. include a polymer film.

The granular thermochromic material, e.g. the pigment, has, for instance, an optional particle size in the range of at least 50 nm or at least 100 nm and/or up to 250 nm.

The particle size of the granular thermochromic material is for instance measured using a laser diffraction particle size analyzer, and volume equivalent sphere diameter and volume weighted average.

The thermochromic material in granular form, e.g. the pigment composition, is for instance incorporated into a film or foil. The film comprises e.g. a polymeric matrix. The film is e.g. adhesive or self-adhesive. The film e.g. comprises a laminate comprising one or more polymeric layers and one or more layers comprising the thermochromic material. A layer comprising the thermochromic material is e.g. a composite layer comprising particles of the thermochromic material and a matrix, e.g. a polymeric matrix. Such a film is e.g. prepared by a method comprising a step of casting a slurry comprising a liquid phase, a polymer, and particles of the thermochromic material. The casted film is e.g. laminated with other films to produce a laminated film comprising particles of the thermochromic material.

The film or foil can e.g. be applied to float glass, glass windows and glass panels. This can be used e.g. for building and renovating buildings.

In an example embodiment of the coating and thermochromic material, all thermochromic component, e.g. monoclinic VO₂, is formed in situ during a curing or anneal process.

Preferably, the thermochromic component, e.g. VO₂, is included in the thermochromic material or coating in a weight fraction of at least. 10 wt. % and/or less than 50 wt. % relative to all solid components of the thermochromic material or coating, more preferably 20-40 wt. %. Advantageously, the weight fraction of thermochromic component, e.g. VO₂, can be relatively low while providing excellent thermochromic properties of the material or coating.

Preferably, the thermochromic coating or thermochromic material includes the non-thermochromic nanoparticles, preferably with a particle size of at least 10 nm, in a weight fraction of at least. 10 wt. % or at least 20 wt. % or preferably at least 40 wt. % and/or maximum 80 wt. %, preferably 50-70 wt. %, relative to the coating or the material, e.g. relative to all solid components of the coating or of the material. Preferably the preparation methods use corresponding amounts of the (separately prepared) non-thermochromic nanoparticles relative to thermochromic material or coating that is prepared.

Preferably, the thermochromic coating and thermochromic material have a volume ratio of the non-thermochromic nanoparticles to solid binder of at least 1, or at least 2, or at least 3, e.g. less than 10; and preferably the preparation methods use corresponding amounts of the (separately prepared) non-thermochromic nanoparticles and binder precursor component.

Said preferred amounts applies for all preferred types of non-thermochromic nanoparticles, e.g. also for the preferred silica nanoparticles. Preferably the non-thermochromic nanoparticles, present in these amounts, have an average particle size of at least 10 nm or at least 15 nm.

With a lower weight fraction of non-thermochromic nanoparticles, the thermochromic properties, e.g. optical properties in the HT and/or LT state, of the coating or material may be less. With a higher weight fraction of non-thermochromic nanoparticles, the thermochromic properties may become less and/or coating thickness may become undesirably large.

Preferably, the coating or material includes the binder, e.g. silica binder, in an amount of 2-15 wt. %, relative to all solid coating components. In some embodiments, the nanoparticles are silica nanoparticles and the binder is a silica binder and the liquid coating composition includes the nanoparticles and the binder in a Si atom ratio of 5:1 or higher (nanoparticles to binder), such as 10:1 or higher.

Preferably, the thermochromic component is monoclinic VO₂ (e.g. at 5° C.), which is optionally doped with a dopant. The skilled person understands that monoclinic VO₂ refers to the material when below the thermochromic switching temperature. The thermochromic component can also be described as crystalline VO₂; in particular that is monoclinic at 5° C.

The dopant is usually a metal ion in the liquid composition and is e.g. W, e.g. in an amount of up to 5 atom % relative to V, such as at least 0.1 atom %, e.g. 0.2-2.5 atom % relative to V. Other optional dopants include e.g. transition metal ions.

Preferably the coating has a thermochromic switching temperature in the range 10 to 50° C. The thermochromic switching temperature can be determined for example using method A described in WO 2020/242314A1. For instance, the transmission is plotted as function of temperature measured at 1600 nm, yielding a hysteresis plot. The switching point is the temperature at 50% hysteresis width in the plot, with further details as in method A described in WO 2020/242314A1.

The coating is preferably a single layer coating having a thickness of e.g. at least 150 nm or even at least 500 nm.

A non-limiting aspect of the invention provides a method for preparing a thermochromic material, preferably comprising monoclinic VO₂, the method comprising: A) providing, as separate components, a thermochromic precursor component, i.e. a component that is a precursor for a thermochromic component, a binder component, and a component containing, or consisting of, nanoparticles, in particular non-thermochromic nanoparticles, wherein the nanoparticles preferably have an average particle size of at least 10 nm; B) combining at least said components into a liquid composition; C) optionally applying the liquid composition onto a substrate; and D) drying and curing and/or annealing the liquid composition, optionally on the substrate, to give a thermochromic material, optionally in the form of a coated article comprising a solid thermochromic coating. In step A, the three separate components do not need to be simultaneously present; for instance two of the components can be mixed and subsequently the third component is added, also at a different place. The nanoparticles component is, however, during at least some stage of the method, separate and distinct from in particular the binder component.

The invention also pertains to a method for preparing a thermochromic material comprising VO₂, preferably monoclinic VO₂ the method comprising: providing the inventive liquid composition, e.g. the liquid composition comprising in a single liquid phase, a thermochromic precursor component, a binder component, and non-thermochromic nanoparticles having an average particle size of at least 10 nm, wherein the thermochromic precursor component comprises V atoms, preferably is a vanadium organometallic complex, and the method optionally comprises applying the liquid composition onto a substrate; wherein the method comprises drying the liquid composition and curing and/or annealing the dried composition, optionally on the substrate, to give a thermochromic material, optionally in the form of a coated article comprising a solid thermochromic coating. These preparation methods preferably yield the inventive coating and thermochromic product. The preparation methods suitably comprise a cooling step to a temperature below the thermochromic switching temperature, e.g. below 20° C. or below 10° C., to obtain monoclinic VO₂. Optionally, in these preparation method, the VO₂ is doped, and optionally the liquid composition comprises a dopant, such as W solution.

In some embodiments, step D involves annealing to yield crystalline VO₂, for instance annealing of amorphous VO₂ to provide preparing crystalline VO₂, e.g. monoclinic VO₂ (M), in particular as crystallites. In some embodiments, the amorphous VO₂ is provided and annealed as a powder and a granular thermochromic material is obtained. In some embodiments, the amorphous VO₂ is provided as a coating layer on a substrate. The annealing is done e.g. in the presence of an oxygen-containing atmosphere and/or at a temperature of at least 200° C. Preferably, step D comprises drying the liquid composition, e.g. by evaporation of liquid components, e.g. at a temperature of less than 150° C., such as e.g. at a temperature between 20° C. and 100° C.; and subsequently curing the dried material, also referred to as annealing the dried material, to obtain the cured article. It is noted that the presence of the relatively large non-thermochromic nanoparticles in the dried material during the curing and/or annealing, which is substantially free of liquid, may affect the shape and size of the formed VO₂ crystallites and the formation of monoclinic VO2 compared to a reference embodiment using only solid binder (e.g. silica binder), without wishing to be bound by way of theory e.g. by providing interstitial spaces between the nanoparticles in which VO₂ crystallites may form.

The curing, which can also be referred to as annealing, e.g. involves heating the dried material to a temperature above 200° C., or above 300° C. In particular, the non-evaporated thermochromic precursor component is transformed into the thermochromic component during the curing. For instance, vanadium metal complex included in the dried material is cured into VO₂, in particular VO₂ crystallites. Furthermore, for instance the binder is cured into a solid material holding together the nanoparticles and the VO₂ crystallites in the cured material.

An example annealing step involves heating to a temperature above 200° C. or above 300° C., optionally e.g. to a temperature less than 500° C., in an inert atmosphere or in an atmosphere containing oxygen. Example annealing and curing steps that can be used are as mentioned above for the coated article.

Preferably, the binder component is converted during step D into a solid component of the thermochromic material holding together the nanoparticles and the crystalline or monoclinic VO₂, in particular, VO₂ crystallites.

Preferably, the nanoparticles having a size of at least 10 nm are included in the thermochromic material in an amount of at least at least 10 wt. %, or at least. 20 wt. %, preferably at least 40 wt. % of the thermochromic material and/or maximum 80 wt. %, preferably 50-70 wt. %. In preferred embodiments of the preparation methods, a the liquid composition contains the non-thermochromic nanoparticles, having a size of at least 10 nm, in amount corresponding to at least 10 wt. %, or at least 20 wt. %, preferably at least 40 wt. % of the prepared thermochromic material and/or maximum 80 wt. %, preferably 50-70 wt. %.
and a controlled amount of the thermochromic material is prepared by adjusting the amounts of the other components that end up in the cured and/or annealed thermochromic material as necessary.

Generally, in step B the order of mixing is not important, and not all three components need to be present simultaneously and/or in the same place for step A and step B. In some embodiments, step B of the method comprises:
1) providing a liquid composition comprising a vanadium (V) precursor, a reducing agent and a solvent; 2) allowing the vanadium (V) precursor and the reducing agent to react in the presence of a solvent to provide a vanadium (IV) complex solution; 3) precipitating or forming amorphous VO₂ from said vanadium (IV) complex solution in the presence of at least part of said solvent, unreacted reducing agent, and/or reacted reducing agent, thereby obtaining a composition comprising amorphous VO₂; and step D involves: subsequently subjecting said composition to said annealing to provide crystalline monoclinic VO₂ (M); wherein non-thermochromic particles are added in any of the steps of step B or at least before step D. Preferably step D involves drying of the composition, e.g. removal of solvent.

In some embodiments, step C and D are used and the method involves drying and curing the liquid composition, applied as liquid coating on a substrate, to provide a thermochromic coating.

Also provided is a method of preparing a liquid coating composition comprising steps A and B. The prepared liquid composition is in particular a mixture comprising the thermochromic precursor component, the binder component, and the nanoparticles, and optional further components such as dopants. The invention also provides, in an aspect, a liquid coating composition prepared in this way.

For preparing a granular thermochromic material, optional step C is not used. The method comprises a step of drying the liquid composition to remove at least part of the liquid components from the liquid composition, e.g. by evaporation, to give a dried material, as part of step D.

Also provided is a method of preparing a thermochromic material from a liquid coating composition according to the invention, the method comprising providing the inventive liquid composition, or providing a liquid composition obtainable by steps A and B, followed by optionally step C and step D. Step C is used if a thermochromic coating is prepared.

The method involves in step A providing at least three components as separate components. This means that said three components are provided as physically separate components, which are combined in step B. Preferably, the separate components are each separately provided as a liquid material (e.g. suspension, solution), or as a granular, e.g. particulate, material, which materials can be mixed.

A further aspect of the invention is a liquid coating composition comprising, in a single liquid phase, a thermochromic precursor component, a binder component, and nanoparticles. Accordingly, the composition comprises a mixture of a thermochromic precursor component, a binder component, and nanoparticles. This liquid composition in principle can be prepared in any suitable way. Details and preferences of the liquid coating composition are discussed hereinafter.

The thermochromic material and coating preferably comprise VO₂ as thermochromic component. The thermochromic precursor component of the preparation methods and the liquid coating composition preferably comprises V atoms, including for instance V ions. The thermochromic precursor component is suitable to be converted into the thermochromic component, in particular into VO₂, more in particular crystalline VO₂, by curing and/or annealing the coating or dried material.

The thermochromic precursor component is preferably a vanadium organometallic complex, and is preferably a precursor for VO₂ as thermochromic compound.

The vanadium metal complex is preferably an organometallic V(IV) complex which comprises one or more ligands. The complex preferably comprises as ligand a carboxylic acid or conjugate base thereof, in particular a dicarboxylic acid, such as oxalic acid, or the conjugate base of such an acid, such as oxalate. The ligand is e.g. a chelating ligand.

The binder component (which can also be referred to as a component comprising a binder precursor) of the liquid coating composition is suitable to be converted into the solid binder, or solid matrix, of the cured coating. Hence, the binder component (which can also be referred to as a component comprising a binder precursor) of the liquid composition is suitable to be converted into the solid binder, or solid matrix, of the cured thermochromic material or coating, and is converted into a solid binder, or solid matrix, during the curing step of the preparation method. The binder component is for instance in the liquid phase, and is for instance a suspension. The binder component comprises for instance a binder and a liquid dispersion medium.

The binder component is or comprises a binder precursor that typically is a precursor for a solid material, in particular a precursor of a dielectric solid material, and is e.g. a precursor for SiO₂, ZrO₂, TiO₂, Al₂O₃, HfO₂, MgF₂, CaF₂, or an organosiloxane compound.

The precursor is preferably a silica precursor, more preferably pre-oligomerized or oligomerized tetraethyl orthosilicate (TEOS), typically with cross-linkable Si—OH groups.

The binder or binder component or binder precursor typically has film-forming properties. The binder, e.g. in the cured and/or annealed coating or material, preferably has low refractive index, e.g. below 1.9.

The binder component furthermore comprises for instance a compound that is liquid at 20° C. and that is for example a solvent, a dispersion medium, or an alkoxide of Si. The binder component, as separate liquid composition, comprises e.g. at least. 10 wt. % of the binder precursor.

Preferably, the binder component comprises an alkoxysilane or an oligomerized alkoxysilane.

The binder component comprises for instance an alkoxysilane, more preferably tetraethoxysilane. The alkoxysilane may at least in part be oligomerized. Preferably, the binder component comprises an alkoxysilane or an oligomerized alkoxysilane as a binder and a liquid dispersion medium (liquid carrier).

The binder is e.g. pre-oligomerized tetraethoxysilane (POT). In some embodiments, the binder includes silica oligomers.

The liquid dispersion medium is for instance an organic solvent, such as propanol. An example preparation method for POT is described in US 2011/0021335A1. Typically, POT is free or substantially free of particles larger than 7 nm; and the POT may have film-forming properties by transformation of particles into a solid film.

The binder is present as molecular or colloidal species in the binder component, wherein the binder particles, if any, are smaller than 10 nm or even smaller than 7 nm, or smaller than 5 nm. The particle size is e.g. the equivalent area diameter, is e.g. D90 (90% being smaller), and can be determined for instance using electron microscopy.

The nanoparticles, as included in the liquid coating composition, in the cured coating/thermochromic coating, in the thermochromic material, and in the component containing nanoparticles used in the preparation method, and as used in any of the methods, are typically non-thermochromic nanoparticles. The nanoparticles can be identified as being dielectric nanoparticles, and/or having a size of at least 10 nm or at least 15 nm, and/or being non-porous. In preferred example embodiments, the nanoparticles are dielectric nanoparticles with a size of at least 10 nm or at least 15 nm. The nanoparticles preferably have a size below 200 nm or below 100 nm. The dielectric nanoparticles are preferably silica nanoparticles.

In some embodiments, the nanoparticles are non-spherical, e.g. rod-shaped.

The use of a component containing nanoparticles in the preparation method does not mean that the other components used in the preparation method, in particular the thermochromic precursor component and the binder component, must be free of nanoparticles. In embodiments, the binder component may for example include silica oligomers and optionally small silica nanoparticles, e.g. the optional small silica nanoparticles have a size of less than 5 nm.

Importantly, the preferred method of preparing the liquid coating composition involves a step wherein already prepared solid nanoparticles, typically in a dispersion, preferably a stabilized dispersion, are combined with the thermochromic precursor component. In comparison with forming nanoparticles in situ, this provides the advantage that the separately prepared nanoparticles can easily be relatively poor, or even substantially free, of the thermochromic species, e.g. VO₂. Hence, preferably a dispersion of the non-thermochromic nanoparticles is used in the preparation method, more preferably with stabilized nanoparticles, e.g. dispersion that is slightly acidic, e.g. pH 4 to 6.5 or alkaline, e.g. pH of at least. 7.5, or stabilized with a counter ion, e.g. NH₄⁺. Preferably, the dispersion is e.g. aqueous or alcoholic, e.g. comprises water, e.g. deionized water, or an alcohol as liquid carrier, or a combination thereof. The dispersion contains e.g. at least 10 wt. % solid nanoparticles. This dispersion is preferably mixed with the thermochromic precursor component.

The nanoparticles are made of a different material than the thermochromic component of the final cured coating and thermochromic material.

In a preferred embodiment, the nanoparticles are substantially free of vanadium atoms. For instance the nanoparticles have an elemental composition including max. 1.0 wt. % V.

The cores or inner parts of the added nanoparticles are typically not altered by the steps of the coating method. In particular, the cores or inner parts of the added nanoparticles are suitably essentially free of thermochromic component and/or essentially free of VO₂ in the final cured coating. Thereby the nanoparticles form optically diluting pockets or zones of the thermochromic coating, in particular zones with preferably dielectric material.

Surprisingly it was found that the effect of diluting the thermochromic component (in particular VO₂) in the cured coating by adding nanoparticles (inventive embodiment) is completely different from, and in terms of optical properties advantageous over, adding more binder (comparative embodiment), even in embodiments wherein the cured binder and nanoparticles both consist of silica.

Without wishing to be bound by way of theory, this difference in diluting effect between the added nanoparticles and the binder, could be due to the nanoparticles being at the relevant length scale, inhomogeneous, compared to adding more binder. Without wishing to be bound by way of theory, this may affect the shape and size of the VO₂ crystallites that are formed during the preparation and are formed from the VO₂ precursor (ion, complex) in the presence of the nanoparticles. It is noted that also the intermediate amorphous VO₂ particles are formed from the precursor (in particular, the vanadium complex) in the presence of the non-thermochromic nanoparticles.

It is preferred that the added nanoparticles are not too small. The nanoparticles are for example at least 10 nm, or at least 15 nm, or at least 20 nm.

The nanoparticles are preferably less than 100 nm or less than 50 nm to avoid Mie scattering and to not reduce transparency of the coating for visible light.

For all aspects of the invention, the nanoparticles, in particular non-thermochromic nanoparticles, preferably comprise, e.g. for at least 90 wt. %, a dielectric material, such as e.g. silica. The non-thermochromic nanoparticles preferably comprise, e.g. for at least 90 wt. %, metal oxide, such as silica. For all aspects of the invention, the nanoparticles, in particular non-thermochromic nanoparticles, for example comprise, e.g. for at least 90 wt. %, one or more selected from the group consisting of metal oxides, metal sulphides, metal nitrides, and metal carbides, and polymers.

Preferably the non-thermochromic nanoparticles comprise at least 90 wt. % of one or more of dielectric materials, such as SiO₂ and Al₂O₃. Also possible are silicate particles, such as aluminosilicates, for instance clay particles, and layered double hydroxides.

Example materials for the non-thermochromic nanoparticles include SiO₂, ZrO₂, TiO₂, Al₂O₃, HfO₂, MgF₂, CaF₂, and organosiloxane compounds. The non-thermochromic nanoparticles preferably have a low refractive index, and preferably high transparency for visible light, preferably are non-absorbing for visible light (380-750 nm).

Preferred materials for the nanoparticles include SiO₂ and Al₂O₃, for example silica.

The non-thermochromic nanoparticles, e.g. nanoparticles of these materials, preferably have a particle size below 200 nm; and preferably a particle size of at least 15 nm.

In a preferred embodiment, for all aspects of the invention, the nanoparticles, in particular non-thermochromic nanoparticles, are dielectric nanoparticles, e.g. metal oxide nanoparticles, more preferably silica nanoparticles. In a preferred embodiment, the nanoparticles in particular non-thermochromic nanoparticles have an average particle size of at least 10 nm, or at least 15 nm, and/or up to 200 nm or up to 100 nm. A particle size below 200 nm may advantageously ensure good optical transparency in visible light (less haze). Preferably, this particle size is applied for dielectric nanoparticles, e.g. metal oxide nanoparticles, more preferably silica nanoparticles.

In preferred example embodiments of all aspects of the invention, the nanoparticles, in particular non-thermochromic nanoparticles, are silica nanoparticles and/or particles with average particle size of at least 10 nm, in particular of 15 nm to 100 nm.

As mentioned, the invention in an aspect pertains to an inventive liquid coating composition (also referred to as a liquid composition) comprising a thermochromic precursor component, a binder component, and nanoparticles; in particular combined in a single liquid phase, e.g. as a liquid mixture. Preferences for these components are as discussed above and as described hereinafter. The liquid coating composition is in particular a liquid mixture comprising these components. The liquid coating composition includes a liquid compound (a component that is liquid at 20° C.) which provides the liquid phase. This liquid compound is e.g. at least in part provided by the binder component. This liquid compound may also be an additional component.

The liquid coating composition comprises e.g. one or more solvents, for instance including a solvent such as an alcohol. The liquid coating composition is typically liquid at 20° C. This contributes to correct application on the substrate.

The liquid coating composition comprises for instance a solvent and a vanadium (V) precursor with a reducing agent. The liquid coating composition comprises for instance a solvent and a vanadium (IV) complex.

The liquid coating composition may optionally further comprise a dopant. The dopant for examples comprises an ion of Mo, W, Ta, Nb, Al, F, or complexes thereof, or a mixture of these ions and complexes thereof. Doping with ions can in particular be used to optimize the optical switching properties and temperature of the cured coating. The cured coating and the coated article may also comprise such dopants.

In an example embodiment, the thermochromic precursor component preferably comprises a vanadium organometallic complex, the binder component preferably comprises an alkoxysilane or an oligomerized alkoxysilane, and the nanoparticles are preferably silica nanoparticles having an average particle size of at least 15 nm and/or less than 100 nm; and more preferably these three preferred components are used in combination, and the silica nanoparticles are e.g. non-porous.

Preferences for the liquid coating composition as an aspect of the invention also pertain to the liquid coating composition prepared by the method of preparing a liquid coating composition or as part of the method of preparing a coated article. The inventive preparation methods preferably use these liquid composition.

Preferably the liquid coating composition comprises V and Si in an atomic ratio in the range 0.5 to 1.1 V:Si; and the same preference applies for the thermochromic material and coating. Preferably the thermochromic precursor component comprises a vanadium organometallic complex, for liquid coating compositions having the V and Si the atomic ratio.

Preferably, the thermochromic material and coating comprises SiO₂ and VO₂ in a weight ratio of 3:1-1:2 SiO₂ to VO₂, preferably 2:1-1:1 SiO₂ to VO₂.

Preferably, the binder component and the nanoparticles both contain Si atoms. Preferably, at least 50 mol. % of the Si atoms, or at least 80 mol. %, in the liquid coating composition is provided by the nanoparticles; the same preference applies for the thermochromic material and coating. Preferably, the binder is a silica precursor and the nanoparticles are silica nanoparticles.

Preferably, the thermochromic coating and thermochromic material comprises silica, wherein at least 50 mol. % of the silica present in the coating or material is provided as the nanoparticles, i.e. by the nanoparticles compartment, e.g. at least 70 mol % or at least 80 mol. %, e.g. less than 90 mol. %.

An example method for preparing the liquid coating composition is for instance combining a solution comprising vanadium complex, with a component comprising nanoparticles, such as a dispersion of silica nanoparticles in a liquid carrier, e.g. a dispersion of amorphous silica nanoparticles, and with a liquid comprising oligomerized alkoxysilane, such as pre-oligomerized tetraethoxysilane (TEOS). The order of mixing is not important. It is preferred to mix the component into a single mixture and to apply the mixture as liquid coating composition onto a substrate. This example method can also be used in an exemplary embodiment of the method for preparing a coated article in steps A and B. The dispersion of silica nanoparticles is preferably stabilized, and is e.g. acidic or alkaline, as discussed above, and preferably has water or alcohol as liquid carrier, as discussed above.

An example preparation method for preparing a coated article according to the invention comprises applying a liquid coating composition according to the invention onto a substrate, using a coating method such as for example dip coating, spin coating, roller coating, spray coating, or curtain coating. It is noted that the presence of the non-thermochromic nanoparticles in the liquid coating composition can be beneficial for applying relatively thick layers of the liquid coating composition on a substrate using e.g. these methods, to obtain a cured coating with an advantageous thickness of e.g. at least 150 nm or even at least 500 nm and wherein the VO₂ is preferably included an amount of 10 to 50 wt. % relative to all solid coating components and/or with the preferred V to Si ratio.

The method further typically comprises a step of drying the coating on the substrate, e.g. by evaporation of liquid components, e.g. at a temperature of less than 150° C., such as e.g. at a temperature between 20° C. and 100° C.

The method further comprises curing the coating, also referred to as annealing the coating, on the substrate to obtain the coated article. In particular, the non-evaporated thermochromic precursor component is transformed into the thermochromic component. For instance, vanadium metal complex included in the dried coating on the substrate is cured into VO₂. Furthermore, for instance the binder is cured into a solid matrix.

An example annealing step involves heating to a temperature above 200° C. or above 300° C., optionally e.g. to a temperature less than 500° C.; though higher temperatures are also possible, in an inert atmosphere or in an atmosphere containing oxygen. Example annealing and curing steps that can be used are described in WO 2020/242314; WO 2021/242109 and WO 2022/010354. The annealing steps typically used, such as those described in WO 2020/242314; WO 2021/242109 and WO 2022/010354, do not significantly affect the nanoparticles component of the liquid coating composition. Thereby the curing or annealing steps can be broadly varied.

A non-limiting aspect of the invention is the method of preparing a coated article which includes both the preparation of the liquid coating composition and the use of that liquid coating composition to prepare the coated article comprising the solid thermochromic coating. Also for this method, the liquid coating composition is preferably as discussed herein before, and all preferences specified for the liquid coating composition prepared as part of this combined preparation method also apply to the method of preparing a liquid coating composition, the inventive liquid coating composition, and the method of preparing a coated article.

The invention also provides a thermochromic material. The thermochromic coating comprises for example a binder, in particular a solid binder, a thermochromic component, e.g. monoclinic VO₂, and non-thermochromic nanoparticles. The skilled person understands that monoclinic VO₂ refers to the material below the thermochromic switch temperature, e.g. below 5° C. The material can also be described as comprising crystalline VO₂ or as comprising VO₂ crystallites or crystalline nanodomains. The binder is a solid material holding together the nanoparticles and the monoclinic VO₂ crystallites. The material comprises e.g. at least 90 wt. % of the solid binder, thermochromic component, e.g. monoclinic VO₂, and non-thermochromic nanoparticles in total. Preferred amounts for the non-thermochromic nanoparticles are as mentioned hereinabove The thermochromic material may in turn be embedded in another material, e.g. be embedded as particles in a polymer film.

The thermochromic material is preferably obtainable by, or obtained, with, the inventive preparation methods.

The material is e.g. a solid thermochromic coating or e.g. granular material. Preferably, the monoclinic VO₂ and non-thermochromic nanoparticles are physically held together by the solid binder in the thermochromic material.

The invention also provides a coated article comprising a substrate and the solid thermochromic coating. All preferences described for the coating of the coated article also apply for the thermochromic coating as such.

The nanoparticles provide for zones with a relatively low concentration of the thermochromic component in the thermochromic material.

The thermochromic component typically exhibits a transmission decrease in infrared (800-2400 nm) from temperatures below a switching temperature to temperatures above said switching temperature, and preferably in the range 800-1600 nm. The switching temperature is for instance in the range 10-100° C., preferably in the range 20-40° C., for example determined using Method A2 described herein. The thermochromic material and coating may comprise doping ions to adjust the switching temperature.

Preferably, the non-thermochromic nanoparticles are essentially free of the thermochromic component, e.g. free of V atoms in case of VO₂ as thermochromic component. This gives an inhomogeneous distribution of V atoms in the coating. This distribution can be observed and/or determined using e.g. transmission electron microscopy-energy-dispersive X-ray spectroscopy (TEM-EDX).

Preferably for the thermochromic material, the thermochromic coating and the coated article, the thermochromic component is VO₂, in particular monoclinic VO₂ (at 5° C.), and the binder is preferably silica. Preferably the nanoparticles are metal oxide nanoparticles; preferably having a size of 10 nm to 150 nm, e.g. silica particles.

The invention also pertains to a coated article obtainable by or obtained with the method according to the invention for preparing a coated article; wherein the coated article comprises a substrate and a thermochromic coating. Preferences and details for the substrate and thermochromic coating of the coated article are the same as described hereinbefore.

The substrate, for all embodiments of the thermochromic coating and the coated article, is generally a solid material, and e.g. comprises or consists of glass, e.g. the substrate is float glass. The substrate is for instance a glass sheet. The glass is for instance silica-based glass, such as soda-lime glass. Optionally, the substrate is already coated, e.g. the substrate is coated float glass, and the thermochromic coating is formed on the coating. For instance a silica coating is used as barrier coating.

The coated article is for instance used as a window pane for a building, in particular as part of an insulating glass unit.

The coated article may comprise additional coatings. The coated article for instance comprises a first surface and an opposed second surface, with for instance the coating according to the invention on the first surface, and an additional coating on the first surface or on the second surface. The second coating for instance reflects long wave IR (e.g. above 1200 nm).

The invention also pertains to insulating glass unit (IGU) comprising a first glass sheet as the coated article having the thermochromic coating on the first surface, and a second glass sheet, wherein an additional coating is applied preferably on the second glass sheet; the insulating glass unit optionally includes one or more further glass sheets. The additional coating for instance reflects long wave IR (e.g. above 1200 nm). The additional coating is for instance a low emissivity coating (low-e coating). The additional coating is for instance a thin metal coating. The additional coating can also be, e.g., combined with the thermochromic coating in a coating stack on the first surface of the first glass sheet. The insulating glass unit typically furthermore comprises a spacer for spacing the glass sheets and a sealing at the edge, thereby providing an insulating gas space between the glass sheets that is filled with e.g. air or a noble gas such as Ar or Kr. In an insulating glass unit, the thermochromic coating is preferably applied on the inner surface of the outer glass sheet, wherein the outer glass sheet is the glass sheet exposed to the outside environment when installed in a building. The additional coating is preferably applied on the inner surface of the inner glass sheet. The inner surface of the glass sheets are the surfaces exposed to the insulating glass space.

The coated article is for instance used for smart window applications for buildings.

Preferably the thermochromic coating has a thickness of at least. 150 nm, or of at least 200 nm, or of at least 300 nm, preferably at least 500 nm or even at least 700 nm, and is preferably provided as a single layer.

The particle size of the non-thermochromic nanoparticles, e.g. dielectric nanoparticles, e.g. SiO₂ nanoparticles, can be measured using e.g. DLS (dynamic light scattering) and SAXS (Small-angle X-ray scattering) or using electron microscopy (EM). For spherical particles, the diameter can be used. For other types of particles, the equivalent diameter can typically be used. Preferably, the median, number average (D50) value is used, in particular the equivalent area diameter measured using EM, for the nanoparticles size, this size e.g. being in the range of 10 nm to 50 nm.

All preferences for the thermochromic coating and thermochromic material apply equally to the product of the preparation methods. All preferences for components of the thermochromic coating and thermochromic material apply equally for the components used in the preparation method, and for the components of the liquid coating composition, and vice versa. All preferences for the thermochromic coating apply also for the thermochromic material, and vice versa.

As used herein, silica is considered a metal oxide.

### EXAMPLES

The invention will now be further illustrated by the following non-limiting examples. These examples do not limit the invention and do not limit the claims.

### Methods

### 1.1 Preparation Vanadyl Oxalate Solution [0.4M] (A)

An oil-bath is pre-heated to 80° C. A bottle with wide bottleneck, equipped with an overhead stirrer and a funnel is placed in the oil-bath. 70.2 g (0.780 mol) oxalic acid and 60.0 g (3.33 mol) demineralized water is added to the bottle and stirred on low stirring speed of 120 rpm for 15 minutes. After 15 minutes, 33.0 g (0.181 mol) V₂O₅ is added to the reaction with small amounts at a time. After addition of the V₂O₅ in approximately 25 minutes, the reaction is stirred for another 30 minutes at 80° C. Subsequently, the oil-bath is removed to allow the mixture to cool to room temperature. When the mixture is at ambient temperature, the mixture is diluted using 740.4 g 2-propanol to obtain a 0.4 M solution.

### 1.2 Preparation Silica Solution [0.4M] (B)

156.3 g (0.750 mol) tetraethoxysilane (TEOS), 135.0 g (7.50 mol) demineralized water, 4.5 g (0.075 mol) acetic acid and 347.3 g 2-propanol are added to an Erlenmeyer under moderate stirring. The solution is stirred for an additional 24 hours at room temperature. After 24 hours, the solution is diluted using 1234.4 g 2-propanol and subsequently acidified by the addition of approximately 1.5 g HNO₃. A 0.4 M silica solution (pH=2) is obtained. The term ‘silica solution’ is used to identify a liquid phase comprising silica species. Solution B can be referred to as pre-oligomerized tetraethoxysilane (POT).

### 1.3 Preparation NP Dispersion [0.4M] (C)

A bottle with wide bottleneck is placed onto a magnetic stirrer. 460 g 2-propanol is added to the bottle. Whilst stirring of about 150-200 rpm, 10 g (0.167 mol) acetic acid is added to the 2-propanol. Subsequently, 30 g silica nanoparticles (40 wt. % suspension in water, average particle size 22 nm, stabilized) is added a little at the time to the solution. The dispersion is stirred for an additional 10 minutes at room temperature before it is used in the coating formulation. The nanoparticles dispersion is an alkaline 40% aqueous dispersion of colloidal silica with a particle size of 22 nm.

### 1.4 Preparation Coating Formulations

The 0.4 M vanadyl oxalate solution A (Method 1.1) is used for the coating formulations, as well as Silica solution B (Method 1.2) and NP dispersion C (Method 1.3). The density of VO₂ (4.57 g/cm³) and SiO₂ (1.5 g/cm³) are assumed. The amounts are indicated in the examples hereinafter.

### 2.0 Preparation of Glass Substrate

The coatings are applied using a dip-coating technique. In this chapter, the pre-treatment of the glass substrate, application of the barrier layer, application of the vanadium-silica layer, and the annealing procedures are described.

### 2.1 Pre-Treatment of Glass-Substrate

Pilkington Optiwhite™ glass and borosilicate glass of 4 mm thick is cut to a size of 5.0×10.0 cm and in a size of 10.0×10.0 cm. The resulting plates are placed into a Branson 8510 ultrasonic bath filled with a mixture of 70 mL hydrogen peroxide, 70 mL ammonium hydroxide, and 12 L demineralized water and ultrasonicated for 2 hours. The glass is then removed from the bath, rinsed with demineralized water, and left to dry at ambient conditions. A silica barrier layer was applied as generally described in Example 1 of WO/2021/242109.

### 2.2 Application of Vanadium-Silica-NP Coating

The thermochromic coating was applied single-sided using dip-coating. To achieve this, one side of the barrier coated glass substrate was masked using d-c-Fix® self-adhesive foil. The substrates were submerged into and retracted from a coating formulation described in Methods para. 1.4 at various dipping speeds of 1 mm/s to 8 mm/s (withdrawal speed) with a holding time of 10 seconds. “Dip speed” is used to refer to the withdrawal speed.

After complete retraction from the coating formulation, the masking foil was removed and the glass substrate was placed on a 6 inch Si wafer/onto quartz pins, the non-coated side of the glass-substrate on facing the Si wafer/the quartz pin. About one minute waiting was used for evaporation of volatile species.

### 2.3 Annealing of Vanadium-Silica-NP Layer Coating

Annealing of the coatings was done using a Jipelec™ Jetfirst PV Rapid Thermal Processor.

### 2.3.2 Annealing in Jipelec™ Jetfirst PV Rapid Thermal Processor

The annealing program used in the Jipelec™ Jetfirst PV Rapid Thermal Processor is described below.

### 2.3.2.1 Two-Step Oven Procedure

In a preset atmosphere containing air, the silicon wafer with coated substrate, glass side facing the lamps used for heating, was heated in 426 seconds till 270° C. and hold 480 seconds isothermal. The chamber is then flushed in 290 seconds into an atmosphere containing a small amount of oxygen (50-500 ppm by volume) in nitrogen.

After flushing, the chamber is heated to a temperature of 425° C. in 376 seconds. Subsequently, the material was further heated till 450° C. for 970 seconds, after which it was kept isothermal for 30 seconds. The gas flow throughout the complete heating cycle was set at 452 cm³/minute at 20° C. and 1 bar whilst retaining the oxygen to nitrogen ratio.

After the isothermal step the gas flow was reduced to 200 cm³/minute and cooled to approximately 250° C. in 250 seconds. The gas flow was at that time increased to 2000 cm³/minute. The glass containing the final product was removed from the oven at a temperature below 150° C. and used as such.

### Method A: Visible Light Transmission and Solar Modulation Values

Tᵥᵢₛ, ΔTₛₒₗ and ΔT_{760-1360 nm} were calculated using transmission data obtained by method A1 and formulas for visible light transmission and solar direct transmission according to NEN-EN 410.

### Tᵥᵢₛ (Visible Light Transmission);

The visible light transmittance τᵥ or Tᵥᵢₛ of the glazing is calculated using the following formula A1:

$${τ}_{ν} = \frac{{\sum }_{λ = 380 nm}^{780 nm} {D}_{λ} τ ( λ ) V ( λ ) Δ λ}{{\sum }_{λ = 380 nm}^{780 nm} {D}_{λ} V ( λ ) Δ λ} \qquad A ‐ 1$$

wherein: D_{λ} is the relative spectral distribution of illuminant D65 (see Publication CIE No. 15, Colorimetry, 3rd ed (2004)); τ(λ) is the spectral transmittance of the glazing: V(λ) is the spectral luminous efficiency for photopic vision defining the standard observer for photometry (see Publication CIE No. 15, Colorimetry, 3rd ed. (2004)): Δλ is the wavelength interval.

### ΔTₛₒₗ (Solar Modulation):

The solar modulation ΔTₛₒₗ is calculated using following formula:

$$Δ {T}_{sol} = {τ}_{e} ( cold ) - {τ}_{e} ( hot )$$

wherein τₑ (cold) is the solar direct transmission of the glazing in the cold state; τₑ (hot) is the solar direct transmission of the glazing in the hot state.

The solar direct transmittance τₑ of the glazing is calculated using the following formula:

$${τ}_{e} = \frac{{\sum }_{λ = 300 nm}^{2500 nm} {S}_{λ} τ ( λ ) Δ λ}{{\sum }_{λ = 300 nm}^{2500 nm} {S}_{λ} Δ λ}$$

wherein S_{λ} is the relative spectral distribution of the solar radiation (see Publication CIE No. 85, Solar spectral irradiance, technical report (1989)); τ(λ) is the spectral transmittance of the glazing; Δλ is the wavelength interval.

### ΔT_{760-1360 nm} (Special Solar Modulation):

The special solar modulation ΔT_{760-1360 nm} is calculated using following formula A-2:

$$Δ {T}_{760 - 1360 nm} = {τ}_{e 760 - 1360 nm} ( cold ) - {τ}_{e 760 - 1360 nm} ( hot ) \qquad A ‐ 2$$

wherein τ_{e760-1360 nm} (cold) is the solar direct transmission of the glazing in the wavelength region between 760-1360 nm in the cold state; τ_{e760-1360 nm} (hot) is the solar direct transmission of the glazing in the wavelength region between 760-1360 nm in the hot state.

The solar direct transmittance τ_{e760-1360 nm} of the glazing in the wavelength region between 760-1360 nm is calculated using the following formula A-3:

$${T}_{e} = \frac{{\sum }_{760 nm}^{1360 nm} {S}_{λ} τ ( λ ) Δ λ}{{\sum }_{760 nm}^{1360 nm} {S}_{λ} Δ λ}$$

wherein S_{λ} is the relative spectral distribution of the solar radiation (see Publication CIE No. 85, Solar spectral irradiance, technical report (1989)); τ(λ) is the spectral transmittance of the glazing; Δλ is the wavelength interval.

### Method A1: Optical Measurements

The coatings were analysed using a Perkin Elmer UV/VIS/NIR Spectrometer Lambda 750 with UL150t, this is a spectrometer equipped with an upward looking 150 mm integrating sphere accessory with temperature controlled sample holder. The substrates where heated and cooled at a rate of 1° C./min at 2° C. intervals in a temperature range of −10° C. till 120° C. The subsequent transmission and reflection were measured between 250-2400 nm with 10 nm intervals. The temperature measurement was determined by placing a thermocouple at the coated side, which was facing the integrating sphere.

### Example 1

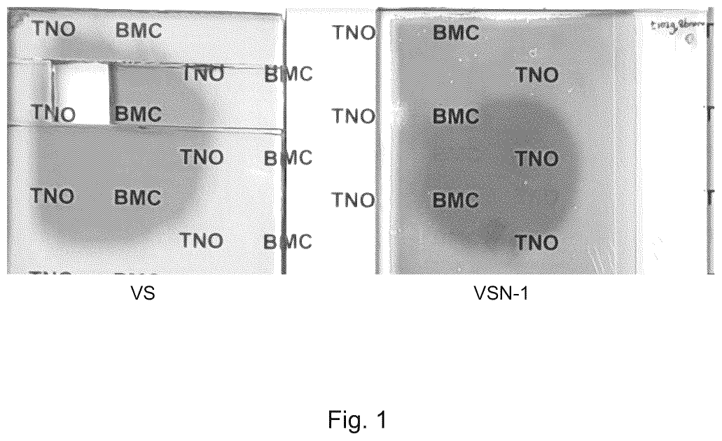

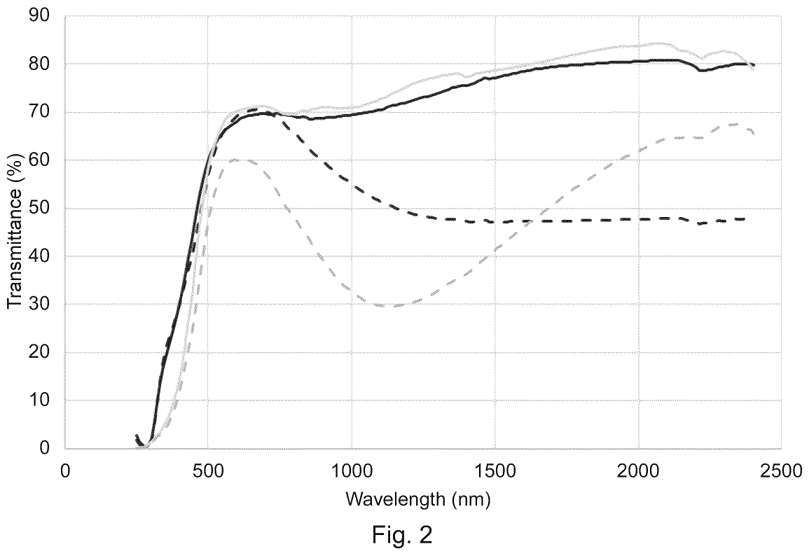

Liquid coating compositions were prepared using the formulations of Table 1, The liquid components were prepared as described under “Methods” and applied to a substrate, using the dip coat withdrawal speed of 3-4 mm/s and annealed in the Rapid Anneal Furnace using the procedure described in subparagraph 2.3.2.1 “Two-step oven procedure”. The pre-treatment of the glass substrate, application of the barrier layer, application of the vanadium-silica layer, and the annealing procedures as described under “Methods” were used. Component A is the thermochromic precursor component, component B is the binder, component C is the nanoparticles component. Table 1 indicates compositions in grams of solution, grams of actual VO₂ respectively silica species in the formulation and the weight fraction of components relative to all solid coating components. Comparative coating VS is the same as sample 2B prepared in Yeung et. al, Solar Energy Materials and Solar Cells, 230 (2021), 111238. Results are given in Table 2 and FIGS. 1 and 2.

FIG. 1 is a picture of the two coatings which are previously mentioned. On the left side is the comparative VS (VO₂—SiO₂) coating and on the right side is the VSN-1 (VO₂—SiO₂-Nanoparticles) coating. The yellow part is the thermochromic part and the green/blue part for the coating does not have thermochromic properties.

FIG. 2 is a graph showing that the addition of non-thermochromic nanoparticles results in a steep decrease in the transmission at wavelengths of 760-1360 nm. This the most interesting part for the thermochromic coating. Dashed line is at 20° C., solid line at 120° C., black is reference sample VS, grey is inventive sample VSN-1.

IR above 1500 nm can typically be blocked by a low e coating of an insulating glass unit of a window pane. Hence, FIG. 2 demonstrates that good optical switching properties are obtained, in particular high transmittance in the LT state for the inventive coating, even with a much thicker coating.

TABLE 1

| | VO₂ | SiO₂ | NP | VO₂ | SiO₂ | NP | VO₂ | SiO₂ | NP |
|---|---|---|---|---|---|---|---|---|---|
| | (A) | (B) | (C) | (A) | (B) | (C) | (A) | (B) | (C) |
| | (g) sol | (g)sol | (g)sol | (g) | (g) | (g) | (wt. %) | (wt. %) | (wt. %) |
| VS * | 240.86 | 109.14 | | 7.99 | 2.62 | 0.00 | 75.29 | 24.71 | 0.00 |
| VSN-1 | 376.39 | 60.17 | 63.73 | 12.49 | 1.45 | 25.49 | 31.67 | 3.67 | 64.66 |

TABLE 2

| | Dip | | | | | |
|---|---|---|---|---|---|---|
| | speed | Layer thickness (nm) | | | | |
| Sample | [mm/s] | Average | | STD | ΔT1200 nm | ΔT1600 nm |
| VS * | 2 | 96 | ± | 11 | 23.1 | 31.2 |
| VSN-1 | 8 | 1045 | ± | 56 | 45.4 | 33.6 |

### Example 2

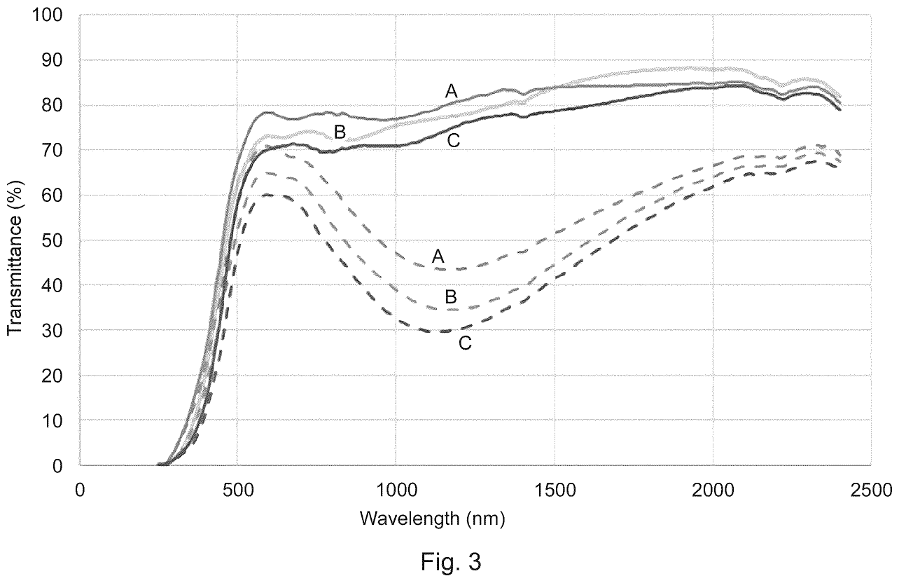

Coatings having substantially the same composition as coating VSN-1 (less than 1% differences in composition) were prepared having a thickness of about 700 nm (A), about 980 nm (B) and about 1020 nm (C) by using a dip withdrawal speed of 4 mm/s, respectively 6 mm/s and 8 mm/s. Coating C was prepared to duplicate coating VSN-1. The optical transmission properties are shown in FIG. 3. Dashed line is at 20° C. (LT), solid line at 120° C. (HT). The addition of nanoparticles consistently results in a steep decrease in the transmission at wavelengths of 760-1360 nm at high temperature, independent of the layer thickness. The valley does not shift in wavelength due to the different thicknesses.

### Example 3

Table 3 shows the thermochromic performance properties of three reference coatings (VS as in Example 1; VS-2 and VS-3) and four inventive coatings (coating VSN-1 of Example 1 and coatings A, B and C of Example 2).

SSF is Tᵥᵢₛ [%] multiplied by ΔTₛₒₗ [%] (numerical values). ΔTₛₒₗ [%] is calculated for 300-2500 nm, and further using Method A described herein. ΔT_{760-1360 nm} is calculated in the same way for the range 760-1360 nm.

ΔG is the difference of total solar energy transmittance (G) through a window panel between the hot and the cold state of the coating, in which per state the G value is calculated according to standard NEN-EN 410:2011; for a double glazing IGU with an additional low-e coating.

TABLE 3

| | VS | VS-2 | VS-3 | | | | |
|---|---|---|---|---|---|---|---|
| | * | * | * | VSN-1 | A | B | C |
| Thickness | | | | 1045 | 700 | 980 | 1020 |
| [nm] | | | | | | | |
| Tᵥᵢₛ [%] | 66.1 | 67.4 | 67.5 | 67.1 | 74.6 | 69.3 | 66.1 |
| ΔTₛₒₗ [%] | 11.8 | 8.9 | 8.6 | 22.9 | 17.5 | 20.7 | 22 |
| ΔT_{760-1360 nm} | 13.7 | 11.6 | 11.8 | 35.7 | 27.2 | 32.1 | 34.5 |
| [%] | | | | | | | |
| SSF | 780 | 600 | 581 | 1537 | 1306 | 1435 | 1454 |
| Tᵥᵢₛ* | 906 | 780 | 798 | 2397 | 2032 | 2224 | 2281 |
| ΔT_{760-1360 nm} | | | | | | | |
| ΔG [%] | 5 | 4 | 3 | 13 | 10 | 11 | 13 |

### Example 4

A coating D was prepared having the same composition as coating VSN-1 and using the same methods as in Example 1. Coating D has high transmittance in the low temperature LT state (20° C.), and significantly lower transmittance in the high temperature HT state (120° C.), in the range 800-1500 nm, with a steep decrease in transmission in the range 700-1200 nm in the HT state. Coating D was analysed using TEM-EDX. The sample was scraped from a coating on a glass substrate according to the invention.

A representative view shown in FIG. 4. The inhomogeneous distribution of V is clearly visible. The pockets that are poor in V correspond to Si rich zones. This confirms that the nanoparticles, spherical nanoparticles of 22 nm in this example, provide for regions of the coating that are poor in thermochromic component.

### Example 5

In preparations of thermochromic materials comprising non-thermochromic particles, generally following Example 1 but modifying component C, different commercially available types of non-thermochromic silica particles dispersion were used as component C, as indicated in Table 4. All samples gave results and thermochromic switching properties comparable to those in Example 1.

TABLE 4

| Sample | Component C |
|---|---|
| 5-A | a commercially available slightly acidic aqueous |
| | dispersion of negatively charged silica particles with a |
| | particle size of 22 nm |
| 5-B | a commercially available alkaline aqueous dispersion of |
| | silica nanoparticles with a particle size of 22 nm, |
| | stabilized with NH₄OH. |
| 5-C | a commercially available alkaline aqueous dispersion of |
| | silica nanoparticles with a particle size of 12 nm, |
| | stabilized with NH₄OH. |
| 5-D | a commercially available slightly acidic alcoholic |
| | (isopropanol) dispersion of elongated silica particles with |
| | a diameter of 9-15 nm and a length of 40 to 100 nm. |

### Example 6

In preparations of thermochromic coatings with non-thermochromic nanoparticles included, generally following Example 1, but modified by using W dopant; with results as indicated in Table 5.

TABLE 5

| Sample | 6A | 6B |
|---|---|---|
| W conc. [atm. %] | 0.5 | 2.3 |
| Tᵥᵢₛ [%] | 65.8 | 64.8 |
| ΔTₛₒₗ [%] | 16 | 14.1 |
| ΔT_{760-1360 nm} [%] | 25.8 | 23.1 |
| SSF | 1053 | 914 |
| Tᵥᵢₛ* ΔT_{760-1360 nm} | 1739 | 1525 |

1. A thermochromic coating comprising a thermochromic material comprising VO₂ and at least one type of non-thermochromic nanoparticles, the coating having the optical characteristics Tᵥᵢₛ×ΔT_{760-1360 nm}>1500, preferably Tᵥᵢₛ×ΔT_{760-1360 nm}>2000; wherein Tᵥᵢₛ is the % visible light transmission and ΔT_{760-1360 nm} is the % transmission modulation in the range 760-1360 nm.

2. A coating according to claim 1, wherein all thermochromic VO₂ is formed in situ during a curing or annealing process.

3. A coating according to claim 1, wherein the VO₂ is included an amount of 10 to 50 wt. % relative to all solid coating components.

4. A coating according to claim 1, which comprises the non-thermochromic nanoparticles in an amount of 40-80 wt. % relative to all solid coating components; and wherein the non-thermochromic nanoparticles have an average particle size of at least 10 nm.

5. A coating according to claim 1, wherein the thermochromic material is monoclinic VO₂, which is optionally doped with a dopant, and preferably has a thermochromic switching temperature in the range of 15° C. to 25° C.

6. A coating according to claim 1, wherein the non-thermochromic nanoparticles are silica nanoparticles having an average particle size of 15 nm to 100 nm.

7. A coating according to claim 1, being a single layer and having a thickness of at least 500 nm.

8. A thermochromic material comprising monoclinic VO₂, which is optionally doped with a dopant; a binder, and at least one type of non-thermochromic nanoparticles, optionally in the form of granular material or a coating; preferably having the features of claim 3.

9. The material according to claim 8, wherein non-thermochromic nanoparticles have an average particle size of 10 to 100 nm, preferably 15 nm to 100 nm; wherein the non-thermochromic nanoparticles are included in the thermochromic material in an amount of at least 10 wt. % of the thermochromic material; and the non-thermochromic nanoparticles are physically held together by the solid binder in the thermochromic material; and wherein the non-thermochromic nanoparticles are preferably silica nanoparticles.

10. A method for preparing a thermochromic material comprising VO₂, the method comprising:
A) providing, as separate components, a thermochromic precursor component comprising a vanadium organometallic complex, a binder component, and a component containing, or consisting of, nanoparticles;
B) combining at least said components into a liquid composition;
C) optionally applying the liquid composition onto a substrate; and
D) drying and curing and/or annealing the liquid composition, optionally on the substrate, to give a thermochromic material, optionally in the form of a coated article comprising a solid thermochromic coating; preferably yielding a thermochromic material or coating according to claim 1.

11. The method according to claim 10, wherein the nanoparticles are nanoparticles having an average particle size of at least 10 nm; and wherein the nanoparticles are included in the thermochromic material in an amount of at least 10 wt. % of the thermochromic material.

12. The method according to claim 10, wherein the binder component comprises an alkoxysilane or an oligomerized alkoxysilane

13. The method according to claim 12, wherein the liquid composition comprises V and Si in atomic ratio in the range 0.5 to 1.1 V:Si.

14. The method according to claim 12, wherein the binder component and the nanoparticles both contain Si atoms.

15. The method according to claim 12; wherein the liquid composition comprises V and Si in atomic ratio in the range 0.5 to 1.1 V:Si; and the nanoparticles are silica nanoparticles.

16. The method according claim 11, wherein the thermochromic material comprises monoclinic VO₂, and wherein the binder component is converted during step D into a solid binder which holds together the nanoparticles and the monoclinic VO₂ in the thermochromic material.

17. A method for preparing a thermochromic material comprising monoclinic VO₂, the method comprising:
providing a liquid composition comprising in a single liquid phase, a thermochromic precursor component, a binder component, and non-thermochromic nanoparticles having an average particle size of at least 10 nm in amount corresponding to at least 10 wt. %, or at least 20 wt. %, preferably at least 40 wt. % of the prepared thermochromic material, wherein the thermochromic precursor component comprises V atoms; wherein the liquid composition is preferably a composition as defined in claim 19; and
drying the liquid composition and curing and/or annealing the dried composition by heating to a temperature above 200° C., to give the thermochromic material, wherein the binder component is converted into a solid binder, the thermochromic material includes the non-thermochromic nanoparticles in a weight fraction of at least 10 wt. %, and the monoclinic VO₂ and the non-thermochromic nanoparticles are physically held together by the solid binder in the thermochromic material; wherein the method preferably gives the thermochromic material or coating according to claim 1.

18. The method according to claim 17, wherein the nanoparticles are silica nanoparticles and/or the binder component comprises an alkoxysilane or an oligomerized alkoxysilane; preferably wherein the liquid composition comprises V and Si in atomic ratio in the range 0.5 to 1.1 V:Si.

19. A liquid coating composition comprising, in a single liquid phase, a thermochromic precursor component, a binder component, and nanoparticles, wherein the thermochromic precursor component is a vanadium organometallic complex.

20. The liquid coating composition of claim 19, wherein the binder component comprises an alkoxysilane or an oligomerized alkoxysilane.

21. The liquid coating composition of claim 19, wherein the nanoparticles are silica nanoparticles having an average particle size of at least 15 nm.

22. The liquid coating composition according to claim 19, wherein the thermochromic precursor component comprises a vanadium organometallic complex.

23. The liquid coating composition according to claim 19, wherein the liquid coating composition comprises V and Si in atomic ratio in the range 0.5 to 1.1 V:Si.
